(19) United States
(12) Patent Application Publication
(10) Pub. No.: US 2008/0271130 A1
(43) Pub. Date: Oct. 30, 2008

(54) MINIMIZING CLIENT-SIDE INCONSISTENCIES IN A DISTRIBUTED VIRTUAL FILE SYSTEM

(76) Inventor: Shankar Ramamoorthy, Albany, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,483

(22) Filed: Apr. 30, 2007

(51) Int. Cl. H04L 9/32

(52) U.S. Cl. 726/9

(57) ABSTRACT

A method of minimizing inconsistencies seen by a client in a distributed virtual file system having multiple clients and a plurality of servers, by creating a token that identifies one of the plurality of servers for creating or modifying a file in the distributed virtual file system. The token has an expiry greater than a propagation time between the identified server and the plurality of servers.

### BACKGROUND

A distributed virtual file system (DVFS) allows a client to access and process files across disparate administrative domains in a distributed pool of servers as if the files physically resided with the client. A human user interfaces with the DVFS through a client device. The client typically requests a token to initiate a session to access a file on a server across the DVFS. The token is usually generated by a server for a client and uniquely identifies the client and the session with the server. The server sends the token with a copy of the file to the client, where they are stored with the client while the file is being processed. The session is typically ended when the client returns the token with its copy of the file.

Multiple clients can create, read, write, and delete files in a distributed virtual file system via a pool of storage servers located behind a load-balancer. The load-balancer can route requests from clients between the storage servers in the pool to ensure that the storage servers have similar loads and so that a server does not become overloaded. Modifications to a file on the DVFS made on one storage server need to be propagated to the other servers in the pool.

Propagation to other servers in the pool can take a certain amount of time. A client may therefore get inconsistent or erroneous results when operating on the same file if the client's requests are served by different storage servers which have an inconsistent view of the same DVFS file. The client's view of a file distributed in the system may be inconsistent across multiple servers until modifications are propagated in the system.

For example, a client X writes a file via server A chosen by the load-balancer from the server pool. Immediately after, client X attempts to read the file back, and this time it talks to storage server B from the server pool. The previous file write may not have propagated or may have been propagated incompletely to server B. Therefore, server B may either report that the file does not exist, or return only a portion of the file. Similarly, if after client X writes the file via server A and before this has propagated to server B, a different client, Y, attempts to read the file via storage server B. Server B may either report that the file does not exist, or return only a portion of the file.

Typical approaches for dealing with file propagation delay include 1) avoiding network communication during the delay and masking the delay in performing other functions, 2) continuing to process requests speculatively and checking for inconsistencies before allowing data out, and 3) configuring load-balancers so that a client always talks to the same server.

When commercial load-balancers are configured so that a client always talks to the same server, load-balancer based stickiness results. The first time a client makes a request, the load-balancer picks a server from the pool and thereafter all requests from the same client are always sent to the same specific server. This can defeat load balancing because an uneven distribution of requests from clients will be reflected in uneven distribution of requests to the storage servers. Performance therefore suffers where there is load-balancer based stickiness.

To enhance performance, storage servers cache information about files and directories. However, like the files they represent, updating this cached information takes time and incoherencies may result before information is propagated from a server modifying a file to the server caching information about the file. Eliminating the caching entirely will ensure that all storage servers have the same view of the DVFS. However, this degrades the DVFS performance unacceptably.

Distributed locking and transacting file operations across all storage servers in the DVFS can ensure that the storage servers always have a consistent view of the DVFS. Again however, this is not practical for performance reasons.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a flow chart depicting a method in accordance with an embodiment of the present invention; and

FIG. 2 is a system illustration in accordance with an embodiment of the present invention.

### DETAILED DESCRIPTION OF EXAMPLE EMBODIMENTS

In describing embodiments of the present invention, the following terminology will be used.

The singular forms “a,” “an,” and “the” include plural referents unless the context clearly dictates otherwise. Thus, for example, reference to “a cell” includes reference to one or more of such cells.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill in the art.

Reference will now be made to the exemplary embodiments illustrated, and specific language will be used herein to describe the same. It will nevertheless be understood that no limitation of the scope of the invention is thereby intended.

One embodiment of the present invention comprises a file token residing with the client wherein the token has an expiry greater than the file propagation time between servers in a distributed virtual file system. The token enables the client to have exclusive file modification privilege until it has expired. The token contains identification of the server creating a file or making modifications to a file and identifies the client making the file creation or modification request. This information concerns the file prior to and during the time the file is being propagated across the servers in the virtual file system by a load-balancer. Since the token prevents other clients from modifying the file during the propagation delay, file inconsistencies seen by other clients are minimized.

The first time a file is written, only the client creating the file has any knowledge of it and therefore other clients will not usually request a token for access before the file has been propagated to all servers in the DVFS pool. Once the file is created and propagated across the DVFS then other clients may request a token for access. The file may be propagated at the local level quickly but can take more time to propagate to remote servers. Therefore, clients distributed over long distances to server pools may have tokens with long expiry times.

After a file is created it may be accessed for reading almost immediately by one or more clients. A client's read request may occur some milliseconds after the file was written while the DVFS propagation delay of the same file may be a longer period of seconds or even minutes. Where the token is used to route a request to the server that wrote the file and not to some other server in the pool, a client can read a file after it is written but before it has been propagated across the DVFS.

The client token may be held in a persistent store on the client side of the network to minimize incoherencies seen by clients caching file information. The token is accessible for reading by all clients in the persistent store. Clients may update tokens in the persistent store.

In an embodiment, a file such as a JPEG image file can be uploaded from a user's desktop to a program that saves the image as a file in the virtual file system. Shortly thereafter, the same virtual file system client may access the file to add additional Exchangeable Image File Format (Exif) header information, and create low-resolution and thumbnail images which are used when displaying the image in a browser. The original image is modified by a single client at any one time after it has been created. Therefore a client requesting a read of an image is routed by a load-balancer to the server identified in the token. A client requesting a write of an image is blocked by the token during the expiry and inconsistencies are minimized.

Figure one depicts a method in accordance with an embodiment of the present invention. The DVFS can be accessible and distributed over the internet or another type of network. The method comprises the operation of creating 10 a token that identifies one of the plurality of servers for creating or accessing a file in the distributed virtual file system. A new token is created whenever an operation modifies a file. The token has an expiry greater than a propagation time between the identified server and the plurality of servers.

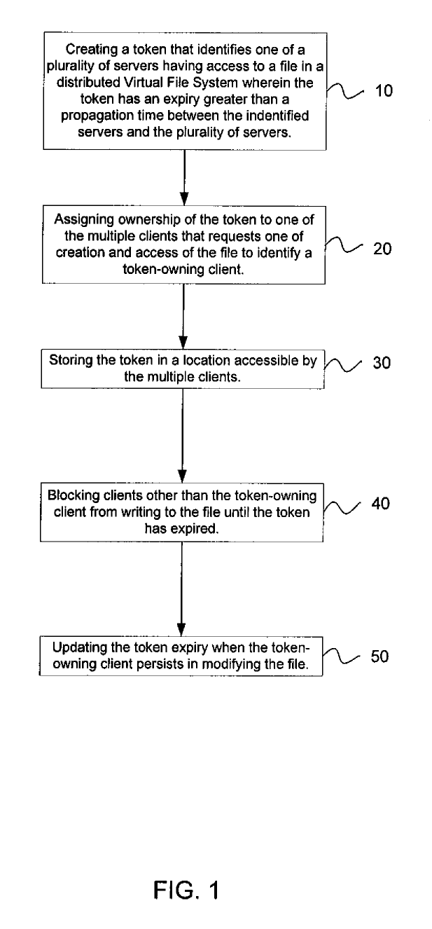

The method of FIG. 1 can further comprise assigning 20 ownership of the token to one of the multiple clients that requests either creation or modification of the file. The method can further include the operation of storing 30 the token in a location accessible by the multiple clients and the client saving the token itself. The method can also include blocking 40 clients other than the token-owning client from writing to the file until the token has expired. The method can additionally comprise updating 50 the token expiry when the token-owning client persists in modifying the file in a method embodiment as depicted in FIG. 1. Not all of the preceding steps are required in all of the embodiments.

Another embodiment of the present invention further comprises the token-owning client sending a file modify request directly to the storage server identified in the token. In a system including a load-balancer, the expiry token-owning client may also send the token and a file modify request to the load-balancer. The load-balancer can act as a proxy for the token-owning client in sending the request to the server identified in the token and transferring a response back to the expiry token-owning client. If the token has expired, the client does not need to send the token to the load-balancer. The load-balancer can send the request to the storage server based on load-balancing and other criteria, as can be appreciated.

Another embodiment of the invention allows a server in the DVFS selected by the load-balancing criteria to be the load-balancer itself. In such an embodiment the load-balancer can process a token-owning client's request to access a file and can transfer the file back to the token-owning client itself.

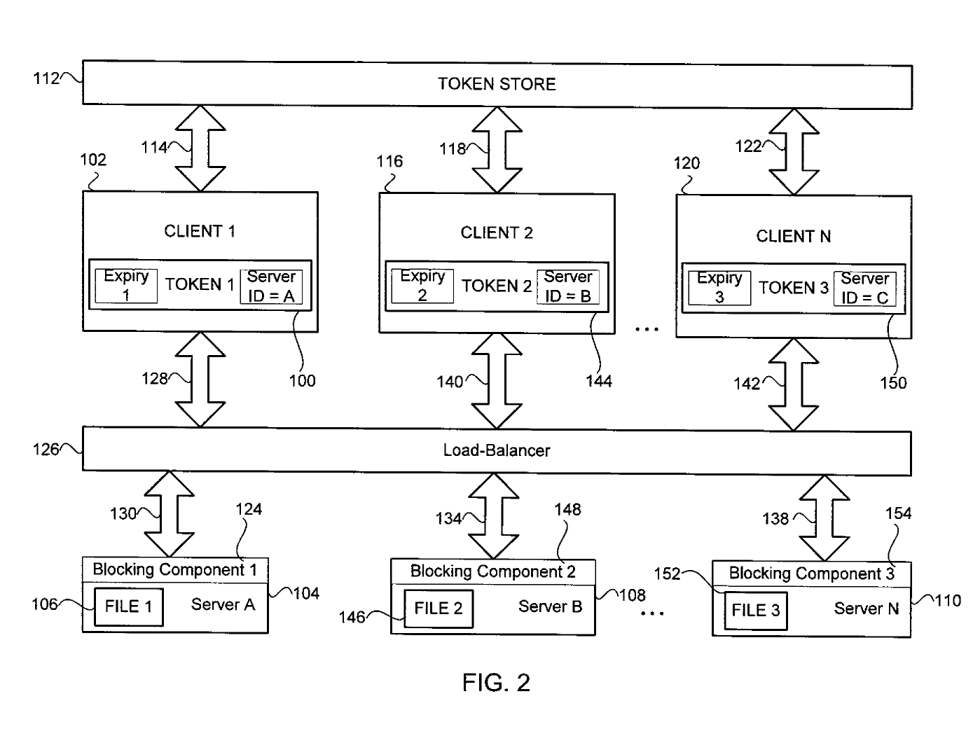

FIG. 2 is an illustration of a system for minimizing inconsistencies seen by a client in a distributed virtual file system, in accordance with an embodiment of the present invention. The system depicts three clients and three servers but can include N multiple clients, coupled to a plurality of N servers through a load-balancer. The system comprises a token 100 for Client One 102 that identifies Server A 104 for creating a first file 106 in the distributed virtual file system. The token 100 has an expiry greater than a propagation time between Server A 104, Server B 108 and Server N 110. Furthermore, the system can include a store 112 for the token 100 in a location accessible by Client One 102 through the communication link 114. The store 112 can also be accessible to Client Two 116 through the communication link 118, and accessible to Client N 120 through the communication link 122. A component 124 for blocking other clients from reading or writing to the first file 106 until the token 100 has expired can be included in Server A 104. The blocking component 124 filters access requests for file 106 accesses. Also Client One 102 can be in communication with the load-balancer 126 through a link 128.

The load-balancer 126 of FIG. 2 can communicate between the multiple clients 102, 116, and 120 and the servers 104, 108, and 110. The load-balancer 126 of FIG. 2 is shown to be in communication with Server A 104 through communication link 130, and in communication with Server B 108 and Server N 110 through communication links 134 and 138 respectively. The load-balancer 126 is also in communication with Client Two 116 and Client N 120 through the communication links 140 and 142 respectively. In accordance with an embodiment of FIG. 2, the token store 112 may also be cached in the multiple clients 102, 116, and 120. Also in an embodiment the servers 104, 108, and 110 are storage servers and the load-balancer 126 and the storage servers 104, 108 and 110 can be the same physical unit.

As depicted in the embodiment of FIG. 2, Client Two 116 owns the second token 144 that identifies Server B 108 for creating a second file 146 in the distributed virtual file system. The second token 144 has an expiry greater than a propagation time between Server A 104 and Server B 108 and Server N 110. Furthermore, there is a store 112 for the token 144 in a location accessible by Client Two 116 through the communication link 118, which is also accessible to Client One 102 through the communication link 114, and accessible to Client N 120 through the communication link 122. A component 148 for blocking other clients from reading or writing to the second file 146 until the token 144 has expired is included in Server B 108.

Client N 120, as depicted in the example embodiment of FIG. 2, owns the third token 150 that identifies Server N 110 for creating a third file 152 in the distributed virtual file system. The third token 150 has an expiry greater than a propagation time between Server A 104 and Server B 108 and Server N 110. Furthermore, there is a store 112 for the token 150 in a location accessible by Client Two 116 through the communication link 118, which is also accessible to Client One 102 through the communication link 114, and accessible to Client N 120 through the communication link 122. A component 154 for blocking other clients from reading or writing to the third file 152 until the token 150 has expired is included in Server N 110.

The system of FIG. 2 can be accessible over the Internet and may be distributed over the Internet or other type of network at any of the communication links 128, 140, and 142. Also any of the communication links 130, 134, and 138 between the load-balancer 126 and the plurality of servers 104, 108, and 110 may be accessible over the Internet or may be distributed over the Internet in accordance with multiple embodiments of the present invention. Furthermore, any of the communication links 114, 118, and 122 may be accessible over the internet or may be distributed over the internet or other type of network to enable the distributed virtual file system clients 102, 116, and 120 to access the token store 112.

In accordance with another embodiment of the present invention, an article of manufacture is disclosed comprising a computer readable medium having computer readable program code means implementing a distributed virtual file system having multiple clients and a plurality of servers. The computer readable medium comprises computer readable code means for creating a token that identifies one of the servers for creating or modifying a file in the distributed virtual file system. The created token has an expiry greater than a propagation time between the identified server and the plurality of servers. The storage media used for containing this code include DVDs, ROMs, tapes, floppy disks, RAM, optical media, and other types of storage media as can be appreciated which are accessible over the internet and distributable over the internet.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method of minimizing inconsistencies seen by a client in a distributed virtual file system having multiple clients and a plurality of servers, comprising creating a token that identifies one of the plurality of servers for either creating or modifying a file in the distributed virtual file system wherein the token has an expiry greater than a propagation time between the identified server and the plurality of servers.

2. The method of claim 1 further comprising configuring the distributed virtual file system to be accessible over the internet and distributed over the internet.

3. The method of claim 1 further comprising:
assigning ownership of the token to one of the multiple clients that requests either creation or modification of the file to identify a token-owning client; and
storing the token in a location accessible by the multiple clients.

4. The method of claim 3 further comprising:
blocking clients other than the token-owning client from writing to the file until the token has expired; and
updating the token expiry when the token-owning client persists in modifying the file.

5. The method of claim 3 further comprising the client saving the token in client's memory store.

6. The method of claim 4 further comprising sending the token and a file modify request from the token-owning client directly to the storage server identified in the token.

7. The method of claim 4 further comprising sending the token and a file modify request from the token-owning client to a load-balancer, wherein the load-balancer is configured to act as a proxy for the token-owning client in sending the request to the server identified in the token and transferring a response back to the token-owning client.

8. The method of claim 4 further comprising configuring the load-balancer to act as a proxy for the token-owning client in the event the token has expired, sending the client request to the storage server based on load-balancing criteria and transferring a response back to the token-owning client.

9. A system for minimizing inconsistencies seen by a client in a distributed virtual file system having multiple clients and a plurality of servers, comprising:
a token that identifies one of the plurality of servers for enacting either creation or modification to a file in the distributed virtual file system wherein the token has an expiry greater than a propagation time between the identified server and the plurality of servers.

10. The system of claim 9 further comprising:
a token-owning client chosen from one of the multiple clients that requests one of creation and modification of the file; and
a store for the token in a location accessible by the multiple clients.

11. The system of claim 10 further comprising:
a component for blocking other clients from reading or writing to the file until the token has expired; and
a component for updating the token expiry when the token-owning client persists in modifying the file.

12. The system of claim 11 wherein the distributed virtual file system is accessible over the internet and distributed over the internet.

13. The system of claim 11 wherein the token also resides with the client.

14. The system of claim 11 wherein the token location is a persistent store.

15. An article of manufacture comprising:
a computer readable medium having computer readable program code means implementing a system for minimizing client-side inconsistencies in a distributed virtual file system having multiple clients and a plurality of servers, wherein the program means further comprises:
computer readable code means for creating a token that identifies one of the plurality of servers for creating or modifying a file in the distributed virtual file system wherein the token has an expiry greater than a propagation time between the identified server and the plurality of servers.

16. The article of manufacture of claim 15 wherein the computer readable medium is accessible over the internet and distributed over the internet.
